(19) United States
(12) Patent Application Publication
(10) Pub. No.: US 2022/0067895 A1
(43) Pub. Date: Mar. 3, 2022

(54) IMAGE PROCESSING DEVICE, IMAGE PROCESSING METHOD, AND IMAGE PROCESSING SYSTEM

(71) Applicant: Oki Electric Industry Co., Ltd., Tokyo (JP)

(72) Inventor: Kazuhiko MAEDA, Warabi-shi, Saitama (JP)

(73) Assignee: Oki Electric Industry Co., Ltd., Tokyo (JP)

(21) Appl. No.: 17/424,117

(22) PCT Filed: Dec. 9, 2019
(86) PCT No.: PCT/JP2019/048052

§ 371 Date: Jul. 19, 2021

(30) Foreign Application Priority Data
Mar. 22, 2019 (JP) 2019-055330

(51) Int. Cl. G06T 5/50; G06T 7/00; G06Q 20/40

(52) U.S. Cl. CPC G06T 5/50; G06T 7/0002; G06T 2207/20172; G06T 2207/30201; G06Q 20/40145

(57) ABSTRACT

An image processing device of the present disclosure includes a camera configured to output a captured image, an image determination section configured to determine based on the captured image output from the camera whether or not the captured image is an image suitable for identity verification of a customer, and a guidance section configured to provide guidance to the customer in a case in which the determination performed by the image determination section results in determination that the image is not suitable for identity verification.

### TECHNICAL FIELD

This application claims priority from Japanese Patent Application No. 2019-055330 filed on Mar. 22, 2019, the disclosure of which is incorporated in its entirety by reference herein.

The present disclosure relates to an image processing device, an image processing method, and an image processing system, and is for example applied to an image processing device, an image processing method, and an image processing system used to perform identity verification.

### BACKGROUND ART

In conventional automated teller machines (ATMs) such as those installed in financial institutions or the like, a host computer is notified over a communication line of the content of account information recorded on a magnetic strip or IC chip of a cash card, as well as a four digit personal identification number (PIN) or the like input in response to on-screen instructions by a customer (user) using the ATM. The host computer performs processing to verify the identity of the customer.

In recent years, biometric authentication methods such as facial authentication are being introduced in various fields, including ATMs of financial institutions. For example, systems exist in which a camera is provided to the ATM to capture a facial image of a customer, and facial authentication is performed by comparing this captured image against pre-registered facial data corresponding to the account holder.

One conceivable approach to improve the accuracy of facial authentication is to improve the quality of captured images. The quality of a captured facial image may be improved simply by the customer looking straight at the camera during imaging.

Japanese Patent Application Laid-Open (JP-A) No. 2002-024913 describes an example in which a light emitting diode (LED) is provided close to a camera, and the LED is illuminated to guide a customer to look toward the camera.

### SUMMARY OF INVENTION

### Technical Problem

However, in the technology disclosed in JP-A No. 2002-024913, insufficient guidance is provided during facial imaging, and there is no particular consideration given to the quality of the captured image. If the quality of the captured image is poor, image verification cannot be correctly performed, resulting in an obstacle to identity verification.

Moreover, in the technology disclosed in JP-A No. 2002-024913, no guidance is provided when retaking an image, and so the technology is insufficient as a guidance means.

An image processing device including a guidance means that takes into consideration convenience for a customer when performing facial authentication is therefore desired.

### Solution to Problem

A first aspect of the present disclosure is an image processing device including (1) a camera configured to output a captured image, (2) an image determination section configured to determine based on the captured image output from the camera whether or not the captured image is an image suitable for identity verification of a customer; and (3) a guidance section configured to provide guidance to the customer in cases in which the determination performed by the image determination section results in determination that the image is not suitable for identity verification.

A second aspect of the present disclosure is an image processing device including (1) a camera configured to output a captured image, and (2) an image determination section configured to determine based on the captured image output from the camera whether or not a target in a captured image meets a predetermined level, and a guidance section configured to provide audio or on-screen guidance in cases the determination performed by the image determination section results in determination that the predetermined level has not been met.

A third aspect of the present disclosure is an image processing device including (1) a camera configured to output a captured image, (2) a light emitting body disposed close to the camera, and (3) a guidance section configured to, in cases in which an image is to be retaken by the camera, provide guidance to a customer using surface light emission from the light emitting body.

A fourth aspect of the present disclosure is an image processing device including (1) a camera configured to output a captured image, and (2) a guidance section configured to provide guidance to a customer accompanying a first imaging when an image is first captured by the camera, and accompanying a second imaging when retaking an image subsequent to the first imaging.

### Effects of Invention

The present aspects enable guidance to be performed while taking into consideration convenience for a customer when performing facial authentication.

### BRIEF DESCRIPTION OF DRAWINGS

FIG. 1 is a block diagram illustrating a configuration of a control system of an automated transaction device of a first exemplary embodiment.

FIG. 2 is an overall configuration diagram illustrating an overall configuration of an authentication system according to the first exemplary embodiment.

FIG. 3 is an external perspective view illustrating an external configuration of an automated transaction device according to the first exemplary embodiment.

FIG. 4 is a flowchart illustrating characteristic operation (image processing for facial authentication) of an automated transaction device according to the first exemplary embodiment.

FIG. 5 is an explanatory diagram (1) illustrating an example of facial state determination results and audio guidance corresponding to the determination results according to the first exemplary embodiment.

FIG. 6 is an explanatory diagram (2) illustrating an example of facial state determination results and audio guidance corresponding to the determination results according to the first exemplary embodiment.

FIG. 7 is an exploded perspective view illustrating an external configuration of an automated transaction device according to a second exemplary embodiment.

FIG. 8 is a diagram illustrating a configuration of an image processing section according to the second exemplary embodiment.

FIG. 9 is a flowchart illustrating characteristic operation (image processing for facial authentication) of an automated transaction device according to the second exemplary embodiment.

FIG. 10 is an external perspective view (1) illustrating an external configuration of an automated transaction device according to a modified exemplary embodiment.

FIG. 11 is an external perspective view illustrating an external configuration of a POS payment terminal according to a modified exemplary embodiment.

FIG. 12 is an external perspective view (2) illustrating an external configuration of an automated transaction device according to a modified exemplary embodiment.

FIG. 13A is an explanatory diagram illustrating an example of on-screen guidance according to the first exemplary embodiment.

FIG. 13B is an explanatory diagram illustrating an example of on-screen guidance according to the first exemplary embodiment.

FIG. 13C is an explanatory diagram illustrating an example of on-screen guidance according to the first exemplary embodiment.

FIG. 14 is a block diagram illustrating a configuration of a control system of an automated transaction device according to a modified exemplary embodiment.

### DESCRIPTION OF EMBODIMENTS

### (A) First Exemplary Embodiment

Detailed explanation follows regarding a first exemplary embodiment of an image processing device of the present disclosure, with reference to the drawings. In the first exemplary embodiment, explanation is given regarding an example in which the image processing device of the present disclosure is applied to an ATM.

### (A-1) Configuration of First Exemplary Embodiment

(A-1-1) Overall Configuration

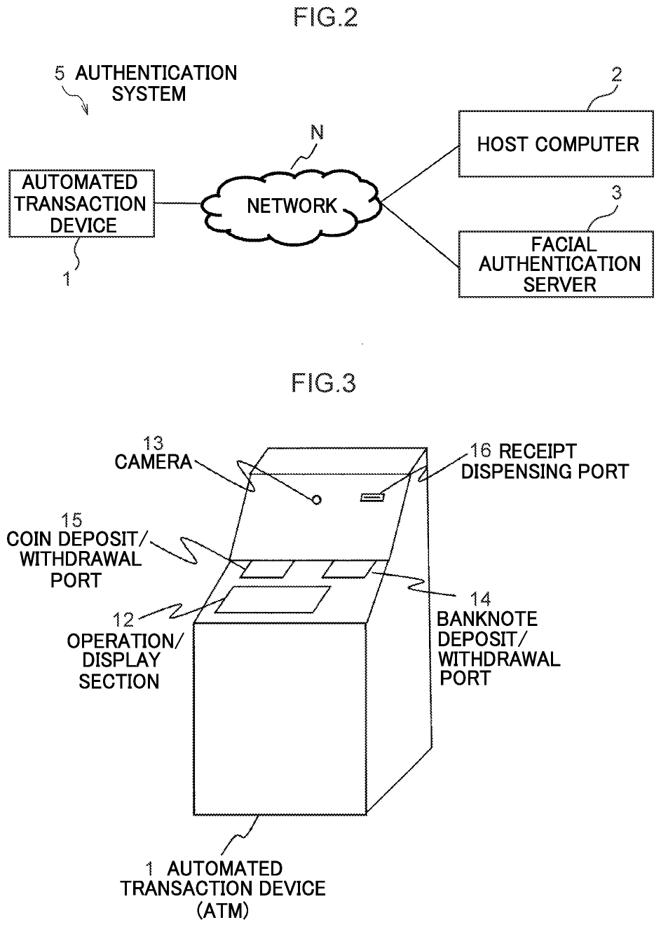

FIG. 2 is an overall configuration diagram illustrating an overall configuration of an authentication system according to the first exemplary embodiment. An authentication system 5 illustrated in FIG. 2 is configured including an automated transaction device 1, a host computer 2, and a facial authentication server 3 that are capable of connecting to a network N.

The network N is a communication network that is capable of communicating data relating to financial transactions, and a dedicated network may be employed therefor. Note that a public network may also be employed as the network N as long as data relating to financial transactions can be communicated.

The automated transaction device 1 is for example an automated teller machine (ATM) provided in a financial institution, train station, convenience store, hotel, or the like. Note that the automated transaction device 1 is not limited to an ATM, and may be any device that performs facial authentication, such as a point of sale (POS) register, a POS payment terminal, or a ticket machine.

The automated transaction device 1 is capable of communicating with the host computer 2 over the network N to perform various financial transactions such as transfers, pay-ins (deposits), and pay-outs (withdrawals). Note that only a single automated transaction device 1 is illustrated in FIG. 2 for simplicity. In reality, plural automated transaction devices 1 would be connected to the host computer 2 over the network N.

The host computer 2 is a host computer of a financial institution. After acquiring information regarding a transaction performed by a customer from the automated transaction device 1, the host computer 2 manages the content of the transaction based on the acquired information relating to the transaction.

The facial authentication server 3 compares a facial image of a customer imaged by a camera or the like and transmitted from the automated transaction device 1 against customer facial image data pre-registered in a database or on a customer card so as to determine whether or not the customer is the correct person. Note that this registered customer facial image data may be a captured image of the face of the customer, or may be feature information including information regarding facial features and so on employed for the purposes of facial authentication.
(A-1-2) Detailed Configuration of Automated Transaction Device 1

FIG. 3 is an external perspective view illustrating an external configuration of the automated transaction device according to the first exemplary embodiment.

As illustrated in FIG. 3, the automated transaction device 1 of the first exemplary embodiment includes an operation/display section 12, a camera 13, a banknote deposit/withdrawal port 14, a coin deposit/withdrawal port 15, and a receipt dispensing port 16.

The operation/display section 12 displays a selection menu screen for selecting a transaction type, operation screens for respective transactions, confirmation screens for confirming transaction contents, and the like, and accepts input information as input by the customer. A touch panel-type operation/display section may be applied as the operation/display section 12. Note that the operation/display section 12 is not limited to a touch panel in which the operation section and the display section are combined into a single unit, and may be configured such that the operation section and the display section are physically separate entities.

The camera 13 includes functionality to use a lens to form an image from an external live image (such as the face of a customer) on an imaging element configured by a charge coupled device (CCD) or a complementary metal oxide semiconductor (CMOS) in order to capture a still image or a moving image.

Note that as a modified example, the automated transaction device 1 may include a monitor disposed close to the camera 13 that displays images captured by the camera 13 (alternatively, the operation/display section 12 may include this functionality).

A customer may insert or remove banknotes through the banknote deposit/withdrawal port 14. A bucket-type port including an opening/closing body that is capable and opening and closing the banknote deposit/withdrawal port 14, or a bucket-type port that does not include such an opening/closing body, may be employed as the banknote deposit/withdrawal port 14. For example, in the case of a bucket-type port including an opening/closing body, when a customer is to insert a banknote, the opening in the bucket is opened by the opening/closing body, the customer then inserts the banknote into the opening in the bucket, and the automated transaction device 1 then closes the opening/closing body and takes in the inserted banknote. When the automated transaction device 1 is to return a banknote, the automated transaction device 1 feeds the banknote into the bucket and then opens the opening/closing body. A banknote deposit port for banknote insertion and a banknote withdrawal port for banknote release are not limited to a single combined unit in the banknote deposit/withdrawal port 14, and the banknote deposit port and the banknote withdrawal port may be configured as physically separate entities.

A customer is able to insert or remove coins through the coin deposit/withdrawal port 15. A bucket-type port including an opening/closing body that is capable and opening and closing an opening of the coin deposit/withdrawal port 15, or a bucket-type port that does not include such an opening/closing body, may be employed as the coin deposit/withdrawal port 15. Similarly to the banknote deposit/withdrawal port 14, for example, in the case of a bucket-type port including an opening/closing body, when a customer is to insert a coin, the opening in the bucket is opened by the opening/closing body, the customer then inserts the coin into the opening in the bucket, and the automated transaction device 1 then closes the opening/closing body and takes in the inserted coin. When the automated transaction device 1 is to return a coin, the automated transaction device 1 feeds the coin into the bucket and then opens the opening/closing body. A coin deposit port for coin insertion and a coin withdrawal port for coin release are not limited to a single combined unit in the coin deposit/withdrawal port 15, and the coin deposit port and the coin withdrawal port may be configured as physically separate entities.

The receipt dispensing port 16 dispenses receipts printed with transaction content.

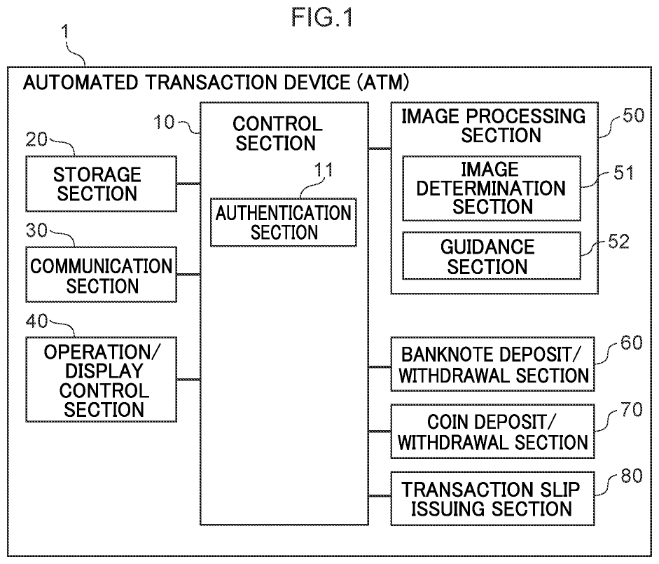

FIG. 1 is a block diagram illustrating a configuration of a control system of the automated transaction device of the first exemplary embodiment. As illustrated in FIG. 1, the automated transaction device 1 includes a control section 10, a storage section 20, a communication section 30, an operation/display control section 40, an image processing section 50, a banknote deposit/withdrawal section 60, a coin deposit/withdrawal section 70, and a transaction slip issuing section 80.

The control section 10 is principally configured by a non-illustrated central processing unit (CPU) that reads a predetermined program from read only memory (ROM), random access memory (RAM), or the storage section 20, and executes the program to control various sections and perform various processing relating to deposit transactions, storage processing, withdrawal transactions, and the like.

The control section 10 includes an authentication section 11 serving as a functional section that coordinates with the facial authentication server 3 and the host computer 2 and performs authentication processing to verify identity by facial authentication and PIN input.

The storage section 20 stores processing programs and the like to be executed by the control section 10, and is configured by a hard disk drive (HDD), a solid state drive (SSD), or the like.

The communication section 30 is a network interface for connecting to the host computer 2 and the facial authentication server 3 over the network N. Note that the communication section 30 is also capable of communicating wirelessly with for example a contactless IC card or a mobile terminal (such as a smartphone) of the customer.

The operation/display control section 40 controls operation of the operation/display section 12 under the control of the control section 10. The operation/display control section 40 displays screens on the operation/display section 12 based on screen information provided by the control section 10, and passes information input to the operation/display section 12 to the control section 10.

Under the control of the control section 10 (authentication section 11), the image processing section 50 provides guidance to the customer so as to capture an image suitable for facial authentication (image authentication) of the customer by the facial authentication server 3.

The banknote deposit/withdrawal section 60 stores and manages banknotes according to denomination under the control of the control section 10.

The coin deposit/withdrawal section 70 stores and manages coins according to denomination under the control of the control section 10.

The transaction slip issuing section 80 prints a transaction outcome onto a transaction slip and issues (dispenses) the transaction slip through the receipt dispensing port 16 under the control of the control section 10.
(A-1-3) Detailed Configuration of Image Processing Section 50

The image processing section 50 includes an image determination section 51 and a guidance section 52.

The image determination section 51 is a functional section that determines whether or not a facial image passed to the facial authentication server 3 is an optimal shot (an image representing a state suitable for facial authentication). Determination as to whether or not the facial image is an optimal shot may be performed taking various factors into consideration, such as at least one parameter of the position of an imaging subject, the angle of the imaging subject, or the size of the imaging subject. More specifically, as described later, determination as to whether or not the facial image is an optimal shot may for example be performed based on three parameters, these being facial position, facial angle, and size. In the present exemplary embodiment, explanation is given regarding an example in which these parameters are employed to determine whether or not a facial image of the customer is an optimal shot. The image determination section 51 determines a captured image to be an optimal shot in cases in which all three parameters are rated “Good”. If even one of these parameters is rated “Bad”, guidance from the guidance section 52 prompts the customer to retake the image. Note that although there are two grades of parameter evaluation in the present exemplary embodiment, these being Good and Bad, evaluation may be performed using more than two grades. In such cases, a captured image may be determined to be an optimal shot in cases in which all parameters are rated with the highest grade.

When repeating imaging until an optimal shot is obtained for a facial image of the customer using the automated transaction device 1, the guidance section 52 for example evaluates whether or not the facial image is an optimal shot based on the facial position, facial angle, and size parameters. In cases in which the facial image is evaluated as not being an optimal shot, the guidance section 52 outputs audio and/or an image according to a priority sequence so as provide guidance for an optimal shot. The guidance section 52 will be described in detail in the upcoming “Operation” section.

### (A-2) Operation of First Exemplary Embodiment

Next, detailed explanation follows regarding transaction processing (principally image processing for facial authentication) performed by the authentication system 5 (automated transaction device 1) according to the first exemplary embodiment, with reference to the drawings.
(A-2-1) Image Processing for Facial authentication

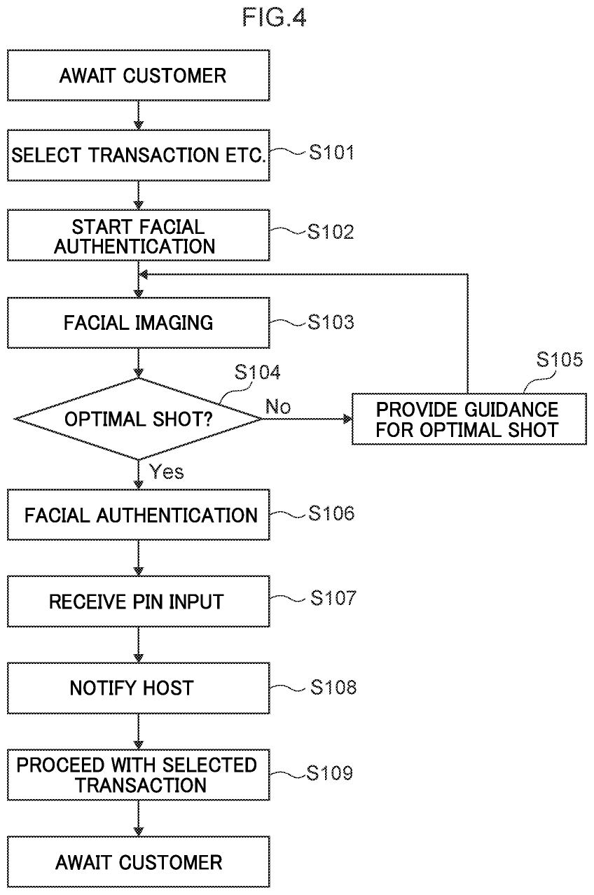

FIG. 4 is a flowchart illustrating operation (image processing for facial authentication) of the automated transaction device according to the first exemplary embodiment.

The automated transaction device 1 (control section 10) starts off in an awaiting customer state. After a customer selects a particular transaction (such as a deposit, withdrawal, cardless transaction, payment, or settlement) (S101), the processing of step S102 is executed. Note that in the case of a cardless transaction, the following processing may be executed even if not selected by the customer (S101).

The control section 10 (authentication section 11) displays an authentication start button (not illustrated in the drawings) on the operation/display section 12 to start execution of authentication processing to verify identity, and receives a button pressing operation (namely the button is touched or selected) by the customer (S102). Within a predetermined duration from receiving that the authentication start button has been pressed by the customer, the control section 10 starts facial imaging, as described below. Alternatively, the control section 10 may start the processing of step S103 immediately (or following a predetermined duration) after the processing of step S101 described above without displaying the authentication start button.

The image processing section 50 uses the camera 13 to execute facial image capture processing for the customer (S103) for the purpose of facial authentication. For example, the image processing section 50 may display an image-capture button (not illustrated in the drawings) on the operation/display section 12, and execute imaging in response to the image-capture button being pressed. The image processing section 50 may also display a screen on the operation/display section 12 during imaging to indicate that imaging is in progress. However, there is no limitation to this example. Alternatively, the image processing section 50 may use the camera 13 to execute customer facial image capture processing for the purpose of facial authentication after displaying a confirm button on the screen of the operation/display section 12. In addition to displaying such an image-capture button or confirm button, the image processing section 50 may also display a message on the screen prompting the customer to remove any extraneous items of clothing, such as “Please take off your hat”, “Please take off any mask or sunglasses”, or “Please take off any hat, mask, or sunglasses”. Note that such a message may be output as audio instead of being displayed on the screen. Alternatively, such a message may take the form of both a screen display and audio output.

On a first round of imaging only, the guidance section 52 may output audio guidance such as “Look straight ahead” as a default, may output a message such as “Look straight ahead” on the screen in addition to such audio guidance, or may output such a message on the screen only, without providing corresponding audio guidance.

Note that the imaging subject (target) is not limited to (the face of) the customer, and may for example be a full-face photograph on a driving license, employee ID card, or identification card, or a full-face photograph displayed on an electronic device such as a smartphone. Moreover, the imaging subject is not limited to a full-face photograph, and may be an encoded image, for example a one-dimensional or two-dimensional code such as a QR code® storing facial information of an individual.

The image processing section 50 (image determination section 51) determines whether or not the facial image captured during the processing of step S103 described above is an optimal shot (i.e., an image of a state suitable for facial authentication) (S104). In cases in which the captured image is an optimal shot, the image determination section 51 executes the processing of step S106, described later. In cases in which the captured image is not an optimal shot, the image determination section 51 executes the processing of next step S105.

In cases in which the captured image is not an optimal shot, the image processing section 50 (guidance section 52) for example executes guidance processing so as to eliminate any “Bad” elements in the parameters of the facial position, facial angle, and size (S105). This guidance processing (and imaging processing) is repeated until all the parameters are rated “Good” (i.e., until a captured image is determined to be an optimal shot in the processing of step S104). Note that further details regarding this guidance processing will be described in part (A-2-2).

In cases in which the captured image is determined to be an optimal shot during the processing of step S104 described above, the control section 10 passes, via the communication section 30, data including the facial image to the facial authentication server 3, and requests facial authentication processing (S106). Note that in cases in which authentication by the facial authentication server 3 is unsuccessful, the control section 10 may end the transaction.

After the customer identity has been verified by facial authentication by the facial authentication server 3 by the processing of step S106 described above, the control section 10 displays an operation screen (not illustrated in the drawings) on the operation/display section 12 in order to receive input of a personal identification number (PIN), and receives PIN input by the customer (S107).

After receiving PIN input, the control section 10 notifies, via the communication section 30, the host computer 2 of the input PIN and information including account information identified based on the facial authentication (S108).

In cases in which the customer identity has been verified by the host computer 2, the control section 10 proceeds with the particular transaction selected at step S101 described above (S109).
(A-2-2) Details regarding the Processing of Step S105 (Optimal Shot Guidance)

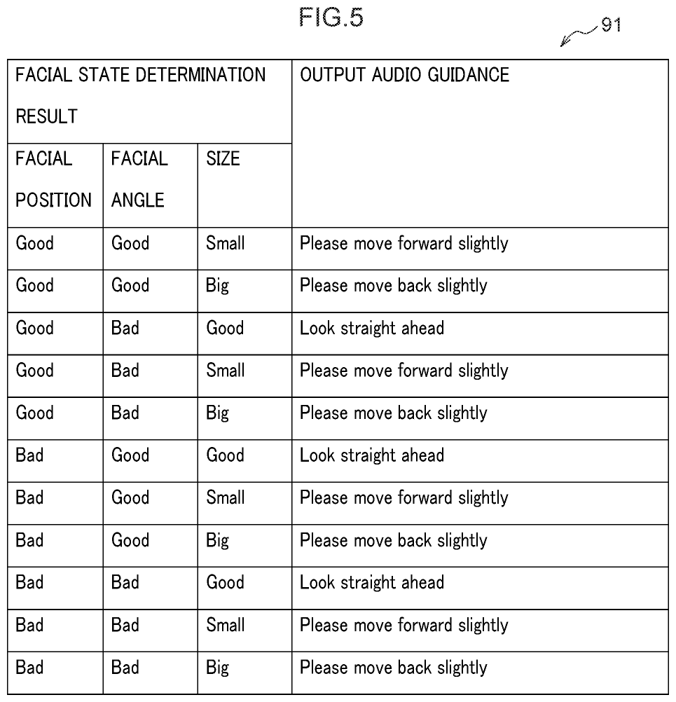

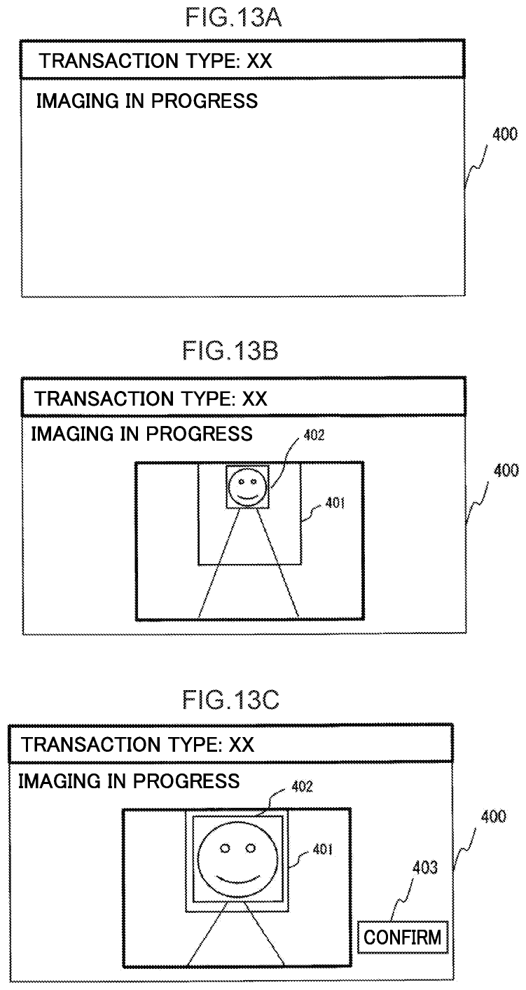

In cases in which imaging is repeated until an optimal shot is obtained for the facial image of the customer using the automated transaction device 1, the guidance section 52 analyzes the ratings of “Bad” for the facial position, facial angle, and size parameters, as in the list 91 illustrated in FIG. 5, and outputs audio and images to provide guidance for an optimal shot according to a priority sequence. Note that a screen such as that illustrated in FIG. 13A is displayed on the operation screen.

Note that facial position refers to the position of the face within the captured image, and is rated “Good” if the face is fully contained within the captured image, and “Bad” if not fully contained therein. The facial angle is rated “Good” if the face is within a correctable range, and “Bad” if outside this correctable range. Size is rated “Good” if the face is contained within the captured image and neither too big nor too small. Size is rated “Small”, i.e. “Bad” if the face in the captured image is too small, and rated “Big”, i.e. “Bad” if the face in the captured image is too big.

In cases in which plural parameters are rated “Bad”, the guidance section 52 for example outputs audio based on a priority sequence of size, then facial angle, and then facial position. In other words, even in cases in which plural parameters are rated “Bad”, the guidance section 52 does not provide audio guidance to resolve the plural “Bad” parameters collectively, but instead provides audio guidance to resolve the “Bad” parameters one by one.

For example, as illustrated in the list 91 in FIG. 5, in cases in which both facial angle and size are rated “Bad”, audio is output to prompt the customer to resolve the problem with the size (for example, audio such as “Please move forward slightly” if the size is unacceptable due to being too small, or “Please move back slightly” if the size is unacceptable due to being too big). In addition to or separately to this audio, when prompting the customer to resolve the problem with the size being small, an illustration or animation to represent the message “Please move forward slightly”, or an icon in which an arrow suggests a direction toward the screen from the perspective of the customer, may be displayed on the screen close to the facial image, or at an edge or a corner of the screen.

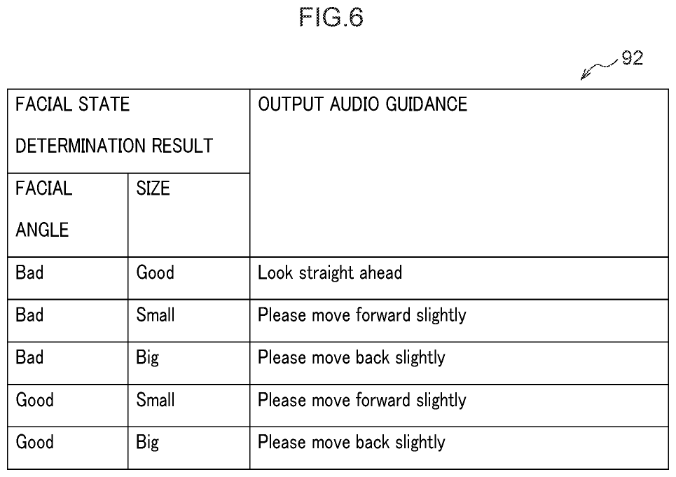

Note that FIG. 5 illustrates an example in which the audio “Look straight ahead” is output in a case in which the facial position is rated “Bad” while the facial angle and size are both rated “Good”. However, different audio may be output depending on the position of the face. For example, in cases in which the facial position is too high in the captured image (or in cases in which the facial position is too far up such that only the lower part of the face can be seen), audio such as “Please crouch down slightly” may be output. In cases in which the facial position is too low (or in cases in which the facial position is too low down such that only the upper part of the face can be seen), audio such as “Please stand up straighter” may be output. Alternatively, the guidance section 52 may omit the facial position parameter, and only provide guidance regarding facial angle and size as illustrated in the list 92 in FIG. 6. In addition to, or separately to this audio output, an illustration or animation to represent the message “Look straight ahead” or “Please stand up straighter”, or an icon in which an arrow points upward from the perspective of the customer, may be displayed on the screen close to the facial image, or at an edge or a corner of the screen.

Instead of or in addition to audio guidance, the guidance section 52 may provide guidance on a screen displayed on the operation/display section 12 (or alternatively, a separate monitor to the operation/display section 12 (a second display section)). For example, the guidance section 52 may display a frame for a captured image and a facial image (live image) in real time on the screen, and/or display at least one of an illustration, animation, or icon on the screen so as to provide guidance such that the facial image is contained within the frame for the captured image.

Although the foregoing description makes no particular reference to the number of times guidance may be provided, in cases in which the number of times guidance is provided exceeds a threshold (for example, twice), the guidance section 52 may provide the above-described on-screen guidance instead of, or in addition to, the audio guidance. Alternatively, on-screen guidance such as that described below may be provided in addition to, or separately to, the audio guidance. For example, in cases in which the facial position is rated “Bad”, as illustrated in FIG. 13B, a square frame representing an image capture range (such as a green square frame 401) and/or a square frame representing the current facial position (such as the red square frame 402) may be displayed on the screen so as to encourage the customer to move such that their facial position is aligned with and contained within the captured image. As another example, a square frame representing the image capture range may be displayed on the screen, the current camera image may be displayed within this square frame, and on-screen guidance and/or audio guidance such as “Please move such that the camera image is contained within this frame” may be provided. Note that the camera image may be that of an avatar (i.e., an avatar whose body movements correspond to those of the customer) instead of the face of the customer. In the case of an avatar, the possibility of the facial image of the customer being captured from behind by a third party is reduced.

Note that in cases in which audio guidance such as “Please move forward slightly” as described above proves ineffective, on-screen guidance such as the green square frame 401 and/or the red square frame 402 may be displayed on the screen. Alternatively, such square frames may be displayed on the screen from the start of facial imaging. Alternatively, as illustrated in FIG. 13C, a confirm button 403 may be displayed on a screen 400, and when the facial image is appropriately contained within the captured image frame as prompted by the on-screen guidance and/or audio guidance, the customer may be asked to select the confirm button 403 such that the image processing section 50 then executes the imaging processing. Alternatively, instead of displaying the confirm button 403, the image processing section 50 may execute the imaging processing when the image processing section 50 determines that the facial image is appropriately contained within a captured image frame. Alternatively, the image processing section 50 may execute the imaging processing when a predetermined duration has elapsed since starting the on-screen guidance and/or audio guidance.

Alternatively, the guidance section 52 may provide guidance regarding an optimal shot immediately after step S102 described above. Namely, the guidance processing of step S105 may be performed continuously, even while the customer is facing the camera 13 but refraining from pressing an imaging button, and in the process of adjusting their facial position. In such cases, audio prompting the customer to press the imaging button may be output when all three parameters are rated “Good” (or alternatively, imaging may be performed automatically without asking the customer to press a button).

In cases in which the automated transaction device 1 includes a handset and the customer is using the handset, audio guidance may be output through this handset. In cases in which the customer is using the handset, the control section 10 (authentication section 11) may switch from facial image authentication to voice authentication automatically (or following selection by the customer).

In cases in which voice authentication is performed, guidance to raise or lower the voice, speak more slowly, or the like may be provided as audio.

### (A-3) Effects of First Exemplary Embodiment

In the first exemplary embodiment, the image processing section 50 repeatedly guides the customer in order to acquire (capture) a facial image that is rated an optimal shot. When performing facial image authentication, a facial image corresponding to an optimal shot is subjected to comparison with verified data, thus enabling the accuracy of facial authentication to be reliably improved compared to hitherto, whatever logic is employed for the facial image authentication.

Moreover, in the automated transaction device 1 of the present exemplary embodiment, identity may be thoroughly verified using both facial authentication and PIN, obviating the requirement for a cash card. Moreover, in cases in which a cash card has been issued, even if this card has been lost or damaged in an emergency, the identity of the customer may be thoroughly verified by facial authentication and the like, enabling transactions such as cash withdrawals to be performed.

### (B) Second Exemplary Embodiment

Next, detailed explanation follows regarding a second exemplary embodiment of an image processing device according to the present disclosure, with reference to the drawings. In the second exemplary embodiment, explanation is given regarding an example in which the image processing device of the present disclosure is applied to an ATM. In the second exemplary embodiment, an example is given in which the ATM captures a facial image of a customer.

### (B-1) Configuration of Second Exemplary Embodiment

Overall configuration of an authentication system 5 according to the second exemplary embodiment is the same as or corresponds to the configuration of the first exemplary embodiment as illustrated in FIG. 2.

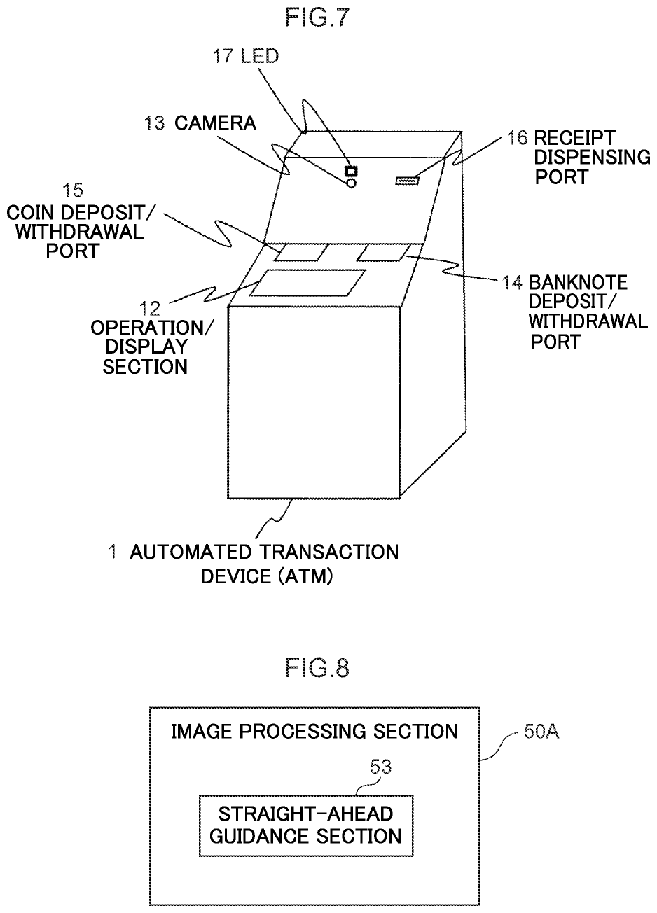

FIG. 7 is an external perspective view illustrating an external configuration of an automated transaction device according to the second exemplary embodiment.

In addition to the configuration illustrated in FIG. 3 and described previously (namely the operation/display section 12, camera 13, banknote deposit/withdrawal port 14, coin deposit/withdrawal port 15, and receipt dispensing port 16), the automated transaction device 1 according to the second exemplary embodiment also includes an LED 17.

The LED 17 is disposed close to the camera 13. When the camera 13 is imaging the face of a customer, as described later, the LED 17 performs a guidance function by causing a blue light emitting diode to light up to encourage the customer to look straight ahead. Although there is no particular limitation to the blue illuminated color of the LED 17, a color that is different from surrounding light emitting bodies is preferably adopted so as to draw the attention of the customer.

Configuration of a control system of the automated transaction device 1 according to the second exemplary embodiment is basically the same as that illustrated in FIG. 1 and described previously. However, an image processing section 50A illustrated in FIG. 8 is employed as an image processing device instead of the image processing section 50. Moreover, the processing performed by the authentication section 11 of the control section 10 differs in part from that in the first exemplary embodiment.

The authentication section 11 of the second exemplary embodiment differs from the first exemplary embodiment in the respect that in cases in which facial authentication is unsuccessful, authentication processing is performed by a question and response relating to information identifying the customer.

The image processing section 50A includes a straight-ahead guidance section 53, and performs processing to acquire an image suitable for image authentication. The straight-ahead guidance section 53 controls the above-described LED 17 such that the LED 17 is illuminated accompanying facial imaging, with the LED 17 being switched off directly after the start of facial imaging, during facial imaging, or after facial imaging.

### (B-2) Operation of Second Exemplary Embodiment

Next, detailed explanation follows regarding transaction processing (principally image processing for facial authentication) performed by the authentication system 5 (automated transaction device 1) according to the second exemplary embodiment, with reference to the drawings.
(B-2-1) Image Processing for Facial Authentication

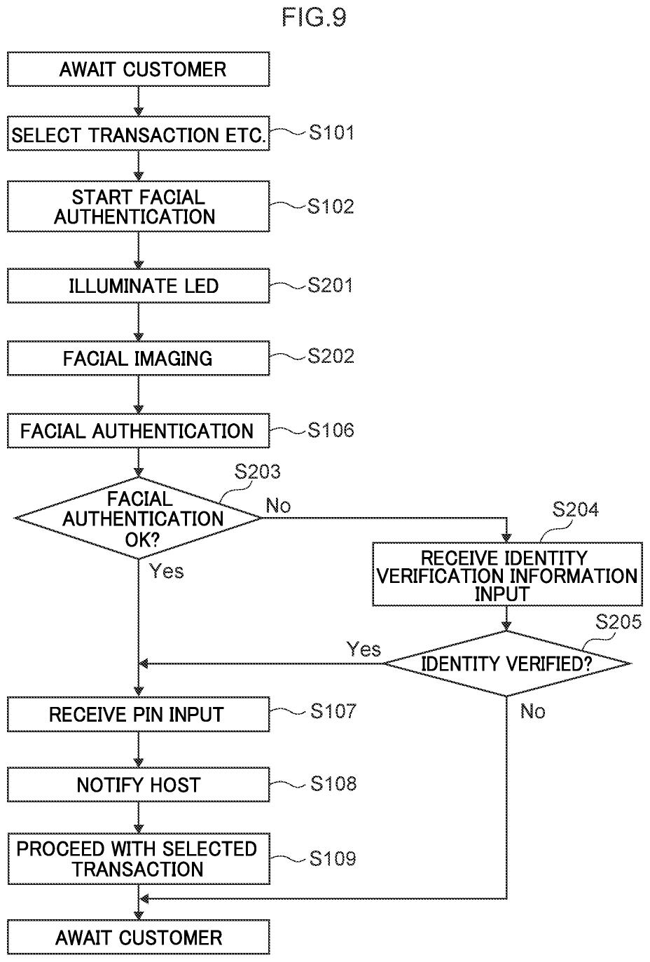

FIG. 9 is a flowchart illustrating characteristic operation (image processing for facial authentication) of the automated transaction device according to the second exemplary embodiment. Note that processing in FIG. 9 that is the same as or corresponds to the characteristic processing according to the first exemplary embodiment illustrated in FIG. 4 is allocated the same reference numerals. Detailed explanation regarding processing that is the same as or corresponds to the characteristic processing according to the first exemplary embodiment illustrated in FIG. 4 is omitted to avoid duplication.

After the processing of step S102 described previously, when the customer selects a transaction button in order to make a deposit transaction or the like on a transaction selection screen, or after the customer has selected a transaction button, the straight-ahead guidance section 53 illuminates the LED 17 to encourage the customer to look directly at the camera (S201). Note that the LED 17 may be made to flash.

After illuminating the LED 17, the image processing section 50A performs facial imaging of the customer, similarly to the processing of step 103 described previously (S202). The LED 17 is switched off directly after the start of facial imaging, during facial imaging, or after facial imaging of the customer.

After facial imaging, the authentication section 11 executes the processing of step 106 described previously, and then determines whether or not facial authentication by the facial authentication server 3 has been successful (S203). In cases in which facial authentication by the facial authentication server 3 has been successful, the authentication section 11 executes the processing of step 107 onward as described previously. In cases in which facial authentication by the facial authentication server 3 has been unsuccessful, the authentication section 11 executes the processing of step S204.

Namely, the authentication section 11 displays a question relating to information identifying the customer using the automated transaction device on the operation/display section 12, and receives input from the customer (S204). Examples of questions relating to information identifying the customer include a date of birth, first name, telephone number, or a preset personal question (such as a parent's maiden name).

The authentication section 11 interrogates, via the communication section 30, the facial authentication server 3 (that includes a database stored with responses to questions) as to whether or not the input information is correct (S205). In cases in which the facial authentication server 3 replies that the response is correct, the authentication section 11 considers that the customer identity has been verified, and executes the processing of step 107 onward as described previously. In cases in which the facial authentication server 3 replies that the response is incorrect, the authentication section 11 either prompts the customer to answer the question again (step S204 described above), or ends the transaction.

Note that in cases in which the response to the question is stored in the automated transaction device 1, there is no need to interrogate the facial authentication server 3, and the automated transaction device 1 may perform identity verification of the customer based on the response to the question internally.
(B-2-2) Modified Example of Processing of Step S202

Accompanying imaging, the image processing section 50A may display on the operation/display section 12 a message such as “Starting imaging”, “Starting imaging - please raise your head”, or “Starting imaging - please look at the light”, or an animation, still image (or icon) or moving image representing such a message.

Furthermore, during imaging the image processing section 50A may display on the operation/display section 12 a message such as “Please hold still” or an animation, still image (or icon) or moving image representing such a message, or may perform such a display together with audio output.

Although such a display may be performed at any given location on the operation/display section 12, the display is preferably shown in an upper part of the screen so as to encourage the customer to raise their face toward the camera 13. Note that a device that displays a message is not limited to the operation/display section 12, and for example a separate monitor may be provided on or above the top of casing of the automated transaction device 1 or close to the camera 13, and the display may be performed on this monitor, with or without an accompanying audio output.

Moreover, the image processing section 50A may perform facial imaging plural times in response to selection by the customer. When capturing an image again, the image processing section 50A may display on the operation/display section 12 a message such as “Capturing fresh image” or an animation, still image (or icon) or moving image representing such a message.

### (B-3) Effects of Second Exemplary Embodiment

In the second exemplary embodiment, the LED 17 exhibits a function of guiding the customer to look straight at the camera 13 that performs facial imaging, thereby enabling a facial image suitable for facial authentication to be captured. The second exemplary embodiment therefore exhibits similar advantageous effects to those described in the first exemplary embodiment.

### (C) Other Exemplary Embodiments

Various modified exemplary embodiments have been suggested in the exemplary embodiments described above. The following modified exemplary embodiments may also be applied to the present disclosure. Moreover, some or all of the components described above in the first and second exemplary embodiments may be applied to a combined exemplary embodiment of the present disclosure.

(C-1) In the automated transaction device of the exemplary embodiments described above, LED lighting (such as a white light) may be additionally provided close to the operation/display section 12 or the LED 17 of the automated transaction device 1, or near to the top of the casing of the automated transaction device 1, in order to augment insufficient lighting or soften excessive lighting around the face. Note that, for example, the brightness of the LED lighting may be adjustable using the operation/display section 12. The white LED may be illuminated when a customer is standing in front of the automated transaction device 1. The automated transaction device 1 may be configured to determine whether or not lighting is excessive or insufficient when performing facial imaging, and to adjust the LED lighting accordingly.

(C-2) Although authentication is performed by facial authentication and PIN input in the automated transaction device 1 of the exemplary embodiments described above, authentication may be performed using fingerprints or palm veins (or iris, vocal cords, or the like) as an alternative to PIN identification. Moreover, the automated transaction device 1 may be configured to verify identity by facial authentication only, without requiring PIN input. In cases in which identity is verified by facial authentication only, there is no need to provide an input section to input the PIN.

(C-3) Although an example has been given in which facial authentication is performed by the facial authentication server 3 in the authentication system 5 of the exemplary embodiments described above, customer facial image data may be pre-stored in the storage section 20 of the automated transaction device 1, such that identity verification by comparing between the captured image and the stored data may be performed in the automated transaction device 1.

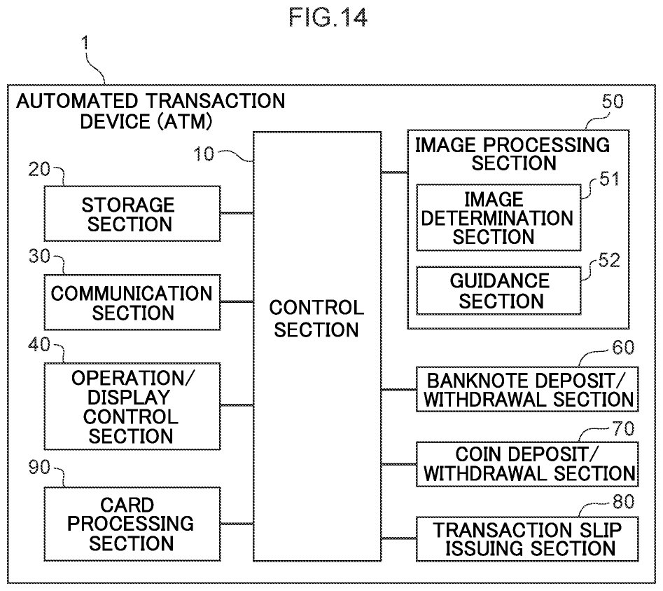

(C-4) An example has been given in which the customer does not use a card in the transactions in the exemplary embodiments described above. However, there is no limitation to such an example, and a card may be used. Namely, as illustrated in FIG. 14, the automated transaction device 1 may include a card processing section 90 that reads information regarding the customer from a magnetic strip and/or an IC chip on a customer card. The customer inserts, scans, or vertically or horizontally slides (or swipes) their card with respect to a card interface. Conceivable card interfaces may include an interface including a card insertion port, a card conveyer means to convey the card, and a means for reading customer information from the card, an interface including a wireless communication means that reads customer information from the card scanned by the customer via contactless wireless communication, and/or an interface including a means to read the customer information from the card slid (or swiped) by the customer. Before, during, or after facial authentication, the customer information may be read from the customer card, and the customer information may be then used to perform facial authentication and/or used to perform identity verification (PIN input, or biometric authentication). Note that biometric information required for facial authentication, vein-based authentication, or the like may be included in the customer information. In cases in which biometric information is not included the customer information, the customer information may be used by the automated transaction device 1 or an external device (such as a server) to acquire this biometric information.

(C-5) Although a transaction selected by a customer has been given as an example of a transaction in the exemplary embodiments described above, there is no limitation thereto. For example, a transaction such as a payment or settlement may be selected by a staff member or attendant (operator). In such cases, the image processing device may be applied to, for example, a POS register, a POS payment terminal, a self-checkout machine, or a ticket machine. In the case of a POS register or a POS payment terminal, when the staff member or attendant selects to perform a transaction or customer identity verification using the POS register, facial imaging of the customer is performed by a camera on the POS register or by a camera on the POS payment terminal connected to the POS register. In cases in which a POS payment terminal serves as an image processing device to perform facial imaging of a customer, selection of a transaction or customer identity verification by a staff member or attendant using a POS register is received by a communication section of the POS payment terminal. In cases in which the image processing device is applied to a self-checkout machine or a ticket machine, a transaction is selected by a customer and facial imaging of the customer is then performed.

(C-6) Although a case in which the face of a customer is imaged has been given as an example of facial authentication in the exemplary embodiments described above, there is no limitation thereto. For example, cases in which a facial image on a driving license, passport, or identification card is imaged, or cases in which a two-dimensional barcode including customer facial information, such as facial feature information required for facial authentication, is imaged may be applied. Moreover, although a case in which authentication is performed based on a facial image generated by facial imaging of the customer and on image data or biometric information (such as fingerprint information or facial feature information) required for facial authentication that has been pre-registered on a card or in the facial authentication server 3 has been given as an example of facial authentication in the exemplary embodiments described above, there is no limitation thereto. For example, authentication may be performed based on a facial image generated by facial imaging of the customer, and on a facial image captured from a photograph on a driving license, passport, or identification card. In such an example, the face of the customer may be imaged in a first round of imaging, and a facial image on a medium such as a driving license may be imaged during a second round of imaging. The order of these first and second rounds of imaging may be reversed. Alternatively, code information representing encoded facial feature information displayed on a mobile terminal such as a smartphone may be imaged, and authentication may be performed based on this imaged code information and a captured facial image of the face of the customer. Alternatively, instead of imaging, facial image data or biometric information stored on a driving license, passport, identification card, IC chip, or mobile terminal may be transmitted through the communication section 30.

(C-7) Although a case in which the facial authentication server 3 performs facial authentication based on a facial image received from a lower tier device such as the automated transaction device 1 has been given as an example of facial authentication in the exemplary embodiments described above, there is no limitation thereto. For example, a lower tier device such as the automated transaction device 1, a POS register, a POS payment terminal, a self-checkout machine, or a ticket machine may perform the facial authentication. In such cases, in order to perform authentication based on a captured facial image of the face of the customer, pre-registered image data or biometric information (such as fingerprint information or facial feature information) required for facial authentication is stored in the lower tier device. Alternatively, the lower tier device may acquire this image data or biometric information by imaging a driving license, a passport, or an identification card, or by communicating with a mobile terminal or an upper tier device (such as the facial authentication server 3).

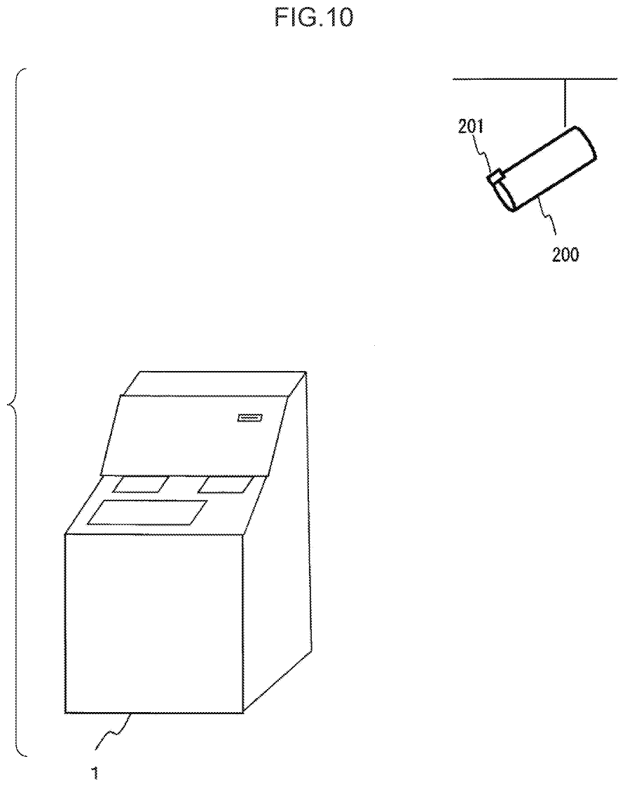

(C-8) Although an example has been given in which the face of a customer is imaged using the camera 13 that is built into the automated transaction device 1 in the second exemplary embodiment described above, an external camera such as that illustrated in FIG. 10 may be employed. FIG. 10 illustrates a monitoring camera 200 that monitors the automated transaction device 1. The monitoring camera 200 includes a lighting section 201 with a similar function to the LED 17, and the lighting section 201 functions as a customer guidance means.

(C-9) Although an ATM has been given as an example of a device applied with an image processing device in the first and second exemplary embodiments described above, as long as the device performs facial authentication similarly to as described in the first exemplary embodiment, the device may be a POS register, a POS payment terminal, a ticket machine, or the like.

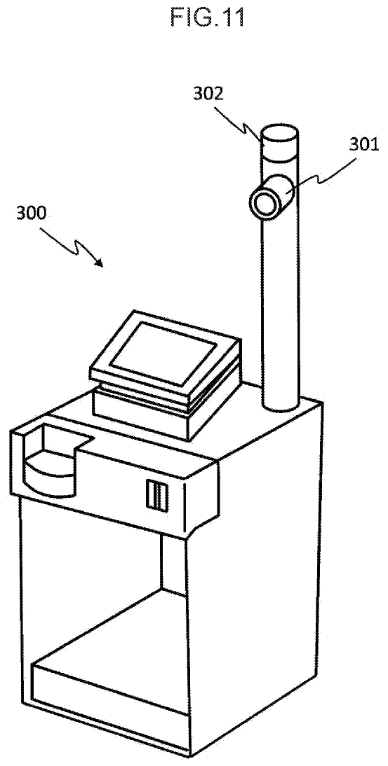

Moreover, a beacon lamp may be employed instead of an LED as a guidance means in such a device. For example, FIG. 11 illustrates a camera 301 that images the face of a customer, and a beacon lamp 302 that is installed close to the camera 301 and that is illuminated or flashes in different colors when imaging the face of a customer.

(C-10) Although an example has been given in which the LED 17 is made to flash as a guidance means for the camera 13 when performing facial imaging in the second exemplary embodiment described above, the guidance means is not limited thereto, and a laser beam, projection mapping, or the like may be employed therefor. For example, the automated transaction device 1 (camera 13) may read a QR code® (i.e., a two-dimensional encoded image of customer facial information) displayed on a smartphone or the like, and shine a laser beam when imaging this QR code® or the like in order to perform facial authentication. The light may be shone over a region of a predetermined size, serving as an illuminated plane. The camera 13 is able to capture the code when part or all of the code is within an optical axis of the shone light, or is within the illuminated plane. The customer will therefore bring their smartphone closer to the laser beam in the vicinity of the camera 13.

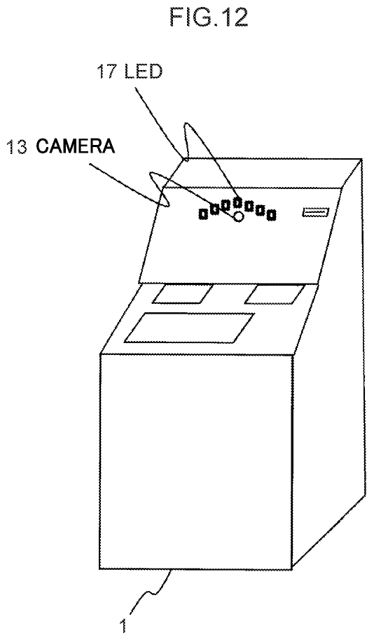

(C-11) Although a single LED 17 is provided close to the camera 13 in the example of the second exemplary embodiment described above, plural LEDs 17 may be provided as illustrated in FIG. 12. In such cases, when performing facial imaging, the LEDs 17 may be illuminated in sequence from the outside, such that the LED 17 closest to the camera 13 is the last to be illuminated (this illumination pattern may be repeated). Alternatively, projection mapping may be employed instead of the LEDs 17 to create a similar illumination pattern.

(C-12) In the second exemplary embodiment described above, the automated transaction device 1 may include a handset similarly to in the modified example of the first exemplary embodiment, and authentication may be performed using audio instead of an image.

(C-13) As a modified example, an image processing device applied to the automated transaction device 1, a POS register, a POS payment terminal, a self-checkout machine, a ticket machine, or the like may employ a combination of some or all of the configurations and functions described in the first and second exemplary embodiments, and/or in the modified examples described (C-1) to (C-11).

(C-14) Although an ATM has been given as an example of a device applied with the image processing device in the exemplary embodiments described above, the image processing device may for example be applied to a safe deposit box or a night safe (a safe door lock management device) that performs facial authentication. For example, using a safe door lock management device including a camera may be employed to image the face (or a QR code® or the like) of the customer while providing audio guidance and/or image guidance similarly to that previously described in order to allow a customer to use a contracted safe. The captured image is then passed to a facial authentication server (including a database stored with facial data used for authentication) to perform facial authentication. After performing identity verification by facial authentication, the safe door lock management device may unlock the contracted safe of the customer, dispense a key (such as a card key) that can be used to unlock the safe, or place a key in an available state. Alternatively, similarly to as previously described, the safe door lock management device may perform identity verification based on PIN input in addition to facial authentication. In order to perform PIN authentication, the safe door lock management device would need to include an input section for inputting the PIN. The camera of the safe door lock management device may include a lighting section serving as a straight-ahead guidance means such as that described previously.

Furthermore, there is no limitation to the above-described example, and the safe door lock management device of the modified example may employ a combination of some or all of the configurations and functions of the first and second exemplary embodiments and/or the modified examples of (C-1) to (C-11) described above.

(C-15) Furthermore, in the exemplary embodiments described above, an image processing device applied to the automated transaction device 1, a POS register, a POS payment terminal, a self-checkout machine, a ticket machine, or the like includes the image determination section 51 to determine whether or not a captured facial image of the face of customer is a facial image suitable for facial authentication. However, the image determination section 51 may be provided to the host computer 2 or the facial authentication server 3. In such an example, the communication section 30 of the image processing device transmits facial image data of the imaged customer face to the host computer 2 or facial authentication server 3 that includes the image determination section 51, and receives facial state determination result data therefrom. The host computer 2 or facial authentication server 3 includes a communication section that transmits and receives data such as the facial state determination result data. For example, a flag indicating whether or not customer guidance is required, a flag indicating whether the state of the facial image is “good” or “bad”, or parameter values regarding facial position, facial angle, and the like may be set in the facial state determination result data. For example, parameter values may be set in the facial state determination result data in cases in which customer guidance is required or cases in which the state of the facial image is poor.

1. An image processing device, comprising:
a camera configured to output a captured image;
an image determination section configured to determine, based on the captured image output from the camera, whether or not the captured image is an image suitable for identity verification of a customer; and
a guidance section configured to provide guidance to the customer in a case in which a result of determination performed by the image determination section is a determination that the image is not suitable for identity verification.

2. The image processing device of claim 1, wherein:
the image determination section is configured to determine, based on the captured image output from the camera, whether or not a target in the captured image attains a predetermined level; and
the guidance section is configured to provide audio or on-screen guidance to the customer in a case in which the image determination section has determined that the predetermined level has not been attained.

3. The image processing device of claim 1, wherein the guidance provided by the guidance section is guidance relating to a facial angle of the customer.

4. The image processing device of claim 1, wherein the guidance provided by the guidance section is guidance relating to a facial size of the customer.

5. The image processing device of claim 2, wherein:
the target is the face of the customer; and
in a case in which a result of determination performed by the image determination section is a determination that at least one of a facial angle or a facial size of the customer has not attained the predetermined level, the guidance section is configured to provide guidance for attaining the predetermined quality level for the at least one of the facial angle or the facial size.

6. The image processing device of claim 1, further comprising:
a light emitting body disposed in a vicinity of the camera,
wherein, in a case in which an image is to be retaken by the camera, the guidance section is configured to provide guidance to the customer using surface light emission from the light emitting body.

7. The image processing device of claim 1, further comprising:
wherein the guidance section is configured to provide guidance to the customer at a time of a first imaging in which an image is first captured by the camera, and at a time of a second imaging in which an image is retaken subsequent to the first imaging.

8. The image processing device of claim 7, wherein:
the guidance at the time of the first imaging is guidance for causing a target in the captured image to look toward the camera; and
the guidance at the time of the second imaging is guidance for attaining the predetermined level for an imaging quality level of the target.

9. The image processing device of claim 1, further comprising an input section configured to receive input of a personal identification number (PIN) by the customer after imaging by the camera has ended.

10. The image processing device of claim 1, further comprising:
an input section configured to receive a selection for a transaction or a customer identity verification,
wherein the image determination section is configured to make a determination regarding the captured image in a case in which the input section has received a selection made by an operator for a transaction or a customer identity verification.

11. The image processing device of claim 1, further comprising:
a communication section configured to receive a selection for a transaction or a customer identity verification from an external device connected to the image processing device,
wherein the image determination section is configured to make a determination regarding the captured image in a case in which the communication section has received a selection made by an operator for a transaction or a customer identity verification.

12. An image processing method, comprising:
determining, based on a captured image output from a camera, whether or not a target in the captured image attains a predetermined level; and
providing audio or on-screen guidance in a case in which a result of the determining is a determination that the predetermined level has not been attained.

13. The image processing method of claim 12, wherein the target in the captured image attaining the predetermined level indicates that the captured image is an image suitable for customer identity verification.

14. An image processing system, comprising:
an image processing device comprising a camera configured to output a captured image; and
a server connected to the image processing device, the server including:
an image determination section configured to receive the captured image from the image processing device and, based on the captured image, to determine whether or not the captured image is an image suitable for identity verification of a customer; and
a transmission section configured to transmit a result of the determination to the image processing device,
wherein the image processing device further comprises a guidance section configured to provide guidance to the customer in a case in which a determination result is a determination that the image is not suitable for identity verification.
